(19) United States
(12) Patent Application Publication
(10) Pub. No.: US 2017/0130514 A1
(43) Pub. Date: May 11, 2017

(54) MIDDLE STRIP OF A DOOR FRAME

(71) Applicant: USA WORLDWIDE DOOR COMPONENTS (PINGHU) CO. LTD., Zhejiang (CN)

(72) Inventors: Jerry Lee Monts De Oca, Zhejiang (CN); Gang ZHOU, Zhejiang (CN)

(21) Appl. No.: 15/228,497

(22) Filed: Aug. 4, 2016

(30) Foreign Application Priority Data
Nov. 6, 2015 (CN) 201510750669.7

(51) Int. Cl. E06B 3/26

(52) U.S. Cl. CPC E06B 3/26

(57) ABSTRACT

The present utility model relates to a middle strip of a door frame, which can effectively solve the problem of insufficient strength existed in the middle strip of the door frame of the prior art. A middle strip of a door frame comprises a middle strip body, wherein a positioning hole is disposed in the middle strip main body along the length direction of the middle strip body, and the positioning hole is provided with a support frame in order to enhance the strength of the middle strip body, and the support frame is arranged along the inner wall of the positioning hole. The present utility model has the following advantages: a positioning hole is disposed in the middle strip body along the length direction, and the positioning hole is provided with a support frame, therefore, he strength of the whole middle strip body is effectively improved via the support frame without changing the size and the shape of the original middle strip body, so that the middle strip body will not deform easily during the using process and has a sufficient strength.

### TECHNICAL FIELD

The present utility model relates to a middle strip of a door frame.

### BACKGROUND

The door frame middle strip is located in the middle position of the door frame, requiring certain bearing capacity. Middle strips in the prior art are made of PVC wood-plastic-foamed material with limited bearing strength, which results in bending deformation or breaking.

### SUMMARY OF THE INVENTION

The objective of the present utility model is to provide a middle strip of a door frame, which can effectively solve the problem of insufficient strength existed in the middle strip of the door frame of the prior art.

To solve the above technical problem, the following technical solution is used in the present utility model: a middle strip of a door frame, comprising a middle strip body, wherein a positioning hole is disposed in the middle strip main body along the length direction of the middle strip body, and the positioning hole is provided with a support frame in order to enhance the strength of the middle strip body, and the support frame is arranged along the inner wall of the positioning hole.

Preferably, the cross-sectional shapes of the positioning hole and the middle strip body are the same, so that the middle strip of the door frame has a uniform thickness and the support frame may play a better supporting function.

Preferably, the cross section of the positioning hole is convex, and the cross section of the support frame is convex as well, both of which have the same shape with the cross-sectional of the middle strip body, therefore improving the supporting effect.

Preferably, the bottom of the support frame is communicated with the positioning hole; and the bottom position is not affected by forces so as to reduce the overall weight and facilitate the filling of the filling block.

Preferably, a filling block, which play a role of sound insulation and heat insulation is also filled in the support frame.

Preferably, the cross-section of the filling block and the support frame, are of the same shapes, which further enhancing the barrier effect.

Compared with the prior art, the present utility model has the following advantages: a positioning hole is disposed in the middle strip body along the length direction, and the positioning hole is provided with a support frame, therefore, he strength of the whole middle strip body is effectively improved via the support frame without changing the size and the shape of the original middle strip body, so that the middle strip body will not deform easily during the using process and has a sufficient strength.

### BRIEF DESCRIPTION OF THE DRAWING

FIG. 1 shows a schematic structural diagram of the door frame middle strip in accordance with the present utility model;

FIG. 2 shows a schematic structural diagram of the middle strip main body in the door frame middle strip in accordance with the present utility model.

### DETAILED DESCRIPTION

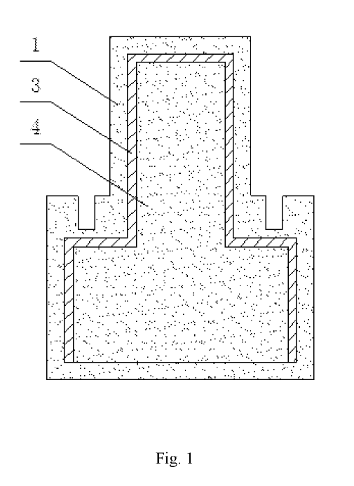

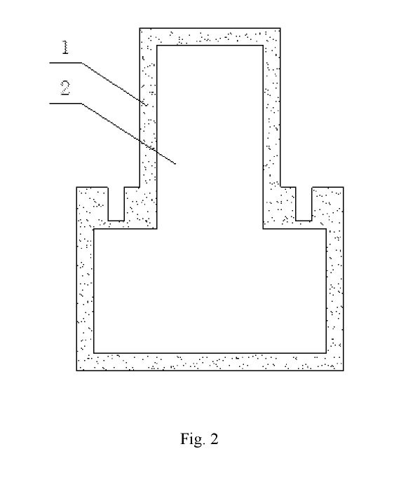

As shown in the FIGS. 1 and 2, embodiments of a middle strip of a door frame in accordance with the present utility model is provided,. A middle strip of a door frame, comprises an middle strip body 1, wherein the cross section of the middle strip body 1 is convex, and a positioning hole 2 is disposed in the middle strip body 1 along the length direction of the middle strip body 1. The cross section of the positioning hole 2 is convex, and the positioning hole 2 is provided with a support frame 3 in order to enhance the strength of the middle strip body 1. The cross section of the support frame 3 is convex as well, and the support frame 3 is made of lightweight materials such as aluminium alloy. The support frame 3 is arranged along the inner wall of the positioning hole 2, and the support frame 3 is filled with a filling block 4, the cross-section of which has the same shape as that of the support frame 3.

In order to facilitate the filling of the filling block 4, the bottom of the support frame 3 has an open structure so as to communicate directly with the positioning hole 2. The filling block 4 has the same material as that of the middle strip body 1, both of which can be made of PVC wood-plastic-foamed material.

First, the middle strip body 1 with the positioning hole 2 is manufactured, then the shaped support frame 3 is filled into the positioning hole 2, and finally, the filling block 4 is filled into the support frame 3 to complete the assembly. The positioning hole 2 is disposed in the middle strip body 1 along the length direction, and the positioning hole 2 is provided with a support frame 3. The strength of the whole middle strip main body 1 is effectively improved via the support frame 3 without changing the size and the shape of the original middle strip body 1, so that the middle strip main body 1 will not deform easily during the using process and has sufficient strength.

The descriptions mentioned above are only specific embodiments of the present utility model, but the technical feature of the present utility model is not limited the specific embodiments. Any changes or modifications made in the field of the present utility model by any people skilled in the art should be contained within the patent scope of the present utility model.

1. A middle strip of a door frame, comprising an middle strip body, wherein: a positioning hole is opened in said middle strip body along the length direction of said middle strip body, and said positioning hole is provided with a support frame in order to enhance the strength of said middle strip body, and said support frame is arranged along the inner wall of said positioning hole.

2. The middle strip of a door frame according to claim 1, wherein: the cross-section of said positioning hole is of the same shape as that of said middle strip body.

3. The middle strip of a door frame according to claim 1, wherein: the cross section of said positioning hole is convex, and the cross section of said support frame is convex as well.

4. The middle strip of a door frame according to claim 3, wherein: the bottom of said support frame is communicated with said positioning hole.

5. The middle strip of a door frame according to claim 1, wherein a filling block is filled in said support frame.

6. The door frame middle strip according to claim 5, wherein: the cross-section of said filling block has the same shape with that of said support frame.
